(19) United States
(12) Patent Application Publication
(10) Pub. No.: US 2023/0228311 A1
(43) Pub. Date: Jul. 20, 2023

(54) CLUTCH ASSEMBLY INCLUDING CALCINED KAOLIN CLAY WET FRICTION MATERIAL WITH IMPROVED DURABILITY

(71) Applicant: Schaeffler Technologies AG & Co. KG, Herzogenaurach (DE)

(72) Inventors: Michael Yanetta, Valley City, OH (US); Rashid Farahati, Copley, OH (US); Dr. Murat Bakan, CANTON, OH (US); Kayla Covington, Dalton, OH (US)

(21) Appl. No.: 17/576,411

(22) Filed: Jan. 14, 2022

(51) Int. Cl. F16D 69/02

(52) U.S. Cl. CPC F16D 69/026; F16D 13/74

(57) ABSTRACT

A clutch assembly for a motor vehicle drivetrain includes a rigid support and a wet friction material fixed to a surface of the rigid support. The wet friction material includes a base material including a matrix of fibers and filler particles embedded in the matrix of fibers; and a binder embedded in the base material. The base material includes, by weight percent, 30-55% cellulose fibers and 10-50% calcined kaolin clay. The base material also includes at least one of 1-20% graphite having a mean particle size of 35 to 85 microns, 20-40% diatomaceous earth in combination with the binder being tung modified phenolic resin, 5-20% chopped aramid fibers, or 5-20% of novoloid fibers.

The present disclosure relates generally to friction clutches and plates used in torque converters and other motor vehicle drivetrain components and more specifically to a clutch assembly including a wet friction material.

### BACKGROUND

The friction material in wet-type friction clutches generally operates in an oil submerged environment and is often paper-based material used to form friction material rings. It is known to form the friction material by a paper making process using a Fourdrinier machine.

U.S. Pub. No. 2018/0149222 A1 discloses a wet friction material that includes aluminum silicate in the form of calcined kaolin clay, disclosing a first general embodiment including 3 to 60% calcined clay, a second general embodiment including 20 to 50% calcined clay, 0 to 30% diatomaceous earth and about 50% cellulose fiber, a first specific example including 50% calcined clay, 50% percent cellulose fiber and a latex binder, and a second specific example including 25% calcined clay, 25% diatomaceous earth, 50% cellulose fibers, and a latex binder.

Graphite having particle sizes of over 100 microns is often used as a friction modifier.

### SUMMARY OF THE INVENTION

A clutch assembly for a motor vehicle drivetrain is provided. The clutch assembly includes a rigid support and a wet friction material fixed to a surface of the rigid support. The wet friction material includes including a matrix of fibers and filler particles embedded in the matrix of fibers; and a binder embedded in the base material. The base material includes, by weight percent, 30-55% cellulose fibers and 10-50% calcined kaolin clay. The base material also includes at least one of 1-20% graphite having a mean particle size of 35 to 85 microns, 20-40% diatomaceous earth in combination with the binder being tung modified phenolic resin, 5 to 20% chopped aramid fibers, or 5 to 20% of novoloid fibers.

A method of making a clutch assembly for a motor vehicle is also provided. The method includes fixing a wet friction material to a surface of a rigid support. The wet friction material is made by providing a base material; saturating the base material with binder; and curing the binder. The base material includes, by weight percent, 30-55% cellulose fibers and 10-50% calcined kaolin clay. The base material also includes at least one of 1-20% graphite having a mean particle size of 35 to 85 microns, 20-40% diatomaceous earth in combination with the binder being tung modified phenolic resin, 5 to 20% chopped aramid fibers, or 5 to 20% of novoloid fibers.

### BRIEF DESCRIPTION OF THE DRAWINGS

The present disclosure is described below by reference to the following drawings, in which:

FIG. 1 schematically illustrates a wet friction material layer in accordance with an embodiment of the present disclosure in a clutch assembly;

FIG. 2 shows a friction versus speed graph for calcined kaolin clay friction materials with and without graphite particles at the start and end of testing cycles;

FIG. 3 shows a friction versus speed graph illustrating calcined kaolin clay friction materials with and without diatomaceous earth;

FIG. 4 shows a friction versus speed graph for calcined kaolin clay friction materials with and without aramid fibers;

FIG. 5 shows a friction versus speed graph for calcined kaolin clay friction materials with and without novoloid fibers at the start and end of testing cycles; and

FIG. 6 shows a clutch assembly including a wet friction material layer bonded to clutch plates in a clutch pack.

### DETAILED DESCRIPTION

Consumers' concerns about the environmental impact of combustion engines is causing the automotive industry to shift their focus towards vehicles that utilize alternative energy sources. As the hybrid and electric vehicle industry grows, friction paper must meet new demands as it is utilized in next generation applications. A new challenge is the need to increase and stabilize the friction coefficient allowing for higher torque applications. In other words, next generation wet friction materials for electric and hybrid applications need to provide higher torque in less space, which requires a higher friction coefficient. To achieve this the material will need to reach and maintain the desired friction coefficient, without excessive wear.

The present disclosure provides a calcined kaolin clay containing friction material includes at least one of chopped aramid fibers, novoloid fibers, diatomaceous earth or graphite, and/or a resin percentage that improves the durability of the high friction material, without a significant loss of friction. These materials can stabilize the friction coefficient over the parts life and increase the durability of the calcined kaolin clay containing friction material compared to the friction materials disclosed in U.S. Pub. No. 2018/0149222 A1.

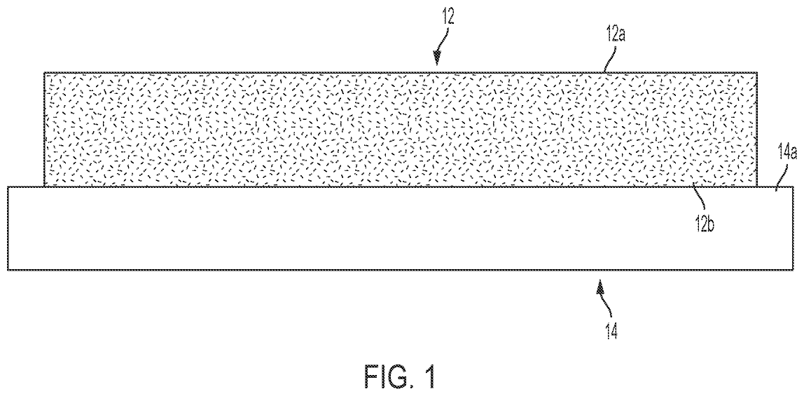

FIG. 1 shows a wet friction material layer 12 bonded to a rigid part in the form of a metal part 14.

A wet friction material layer 12 may be formed of fibers, filler material, a friction modifier and a binder. The fibers are cellulose fibers, chopped aramid fibers and/or novoloid fibers. The filler material includes particles of calcined kaolin clay and optionally diatomaceous earth. The friction modified includes graphite having mean particle sizes of 35 to 85 microns. The binder may be phenolic resin.

As disclosed in U.S. Pub. No. 2018/0149222 A1, the calcined kaolin clay has the chemical formulation of MAl₂O₃NSiO₂, wherein M and N are integers. The exact values for M and N depend on a number of factors including the source of the raw material for the kaolin clay. In an example embodiment, the chemical composition of the calcined kaolin clay may be represented at having an alumina content of at least 35 wt % and at most 55 wt % and a silica content of at least 45 wt % and at most 65 wt %.

The calcined kaolin clay may advantageously have particle sizes 0.5 to 2 microns.

In one preferred embodiment, wet friction material layer 12 may include, before being saturated by the binder, by percentage weight, 30-55% cellulose fibers, 10-50% calcined kaolin clay, 1-20% graphite, 20-40% diatomaceous earth, 5 to 20% chopped aramid fibers and 5 to 20% of novoloid fibers. The binder is 31-35% of the weight of the binder saturated and dried friction material. Thus, the dried friction material would be 20-38% cellulose, 7-35% calcined kaolin clay, 1-14% graphite, 13-28% diatomaceous earth, 3 to 14% chopped aramid fibers and 3 to 14% of novoloid fibers, and 31-35% binder.

The inventors have discovered that modifying the wet friction materials of U.S. Pub. No. 2018/0149222 A1 by substituting 1 to 20% graphite having mean particle sizes of 35 to 85 microns for some of the calcined kaolin clay and using 31 to 35% of the weight of the binder, for example phenolic resin, results in a significant improvement in stability and durability.

In one preferred embodiment with graphite having mean particle sizes of 35 to 85 microns, wet friction material layer 12 may include, before being saturated by the binder, by percentage weight, 40-55% cellulose fibers, 20-49% calcined kaolin clay and 1-20% graphite having a mean particle size of 35 to 85 microns. The binder is tung modified phenolic resin and is 31-35% of the weight of the binder saturated and dried friction material.

In a further preferred embodiment with graphite having mean particle sizes of 35 to 85 microns, wet friction material layer 12 may include, before being saturated by the binder, by percentage weight, 45-55% cellulose fibers, 35-45% calcined kaolin clay and 5-15% graphite having a mean particle size of 35 to 85 microns. The binder is tung modified phenolic resin and is 31-35% of the weight of the binder saturated and dried friction material.

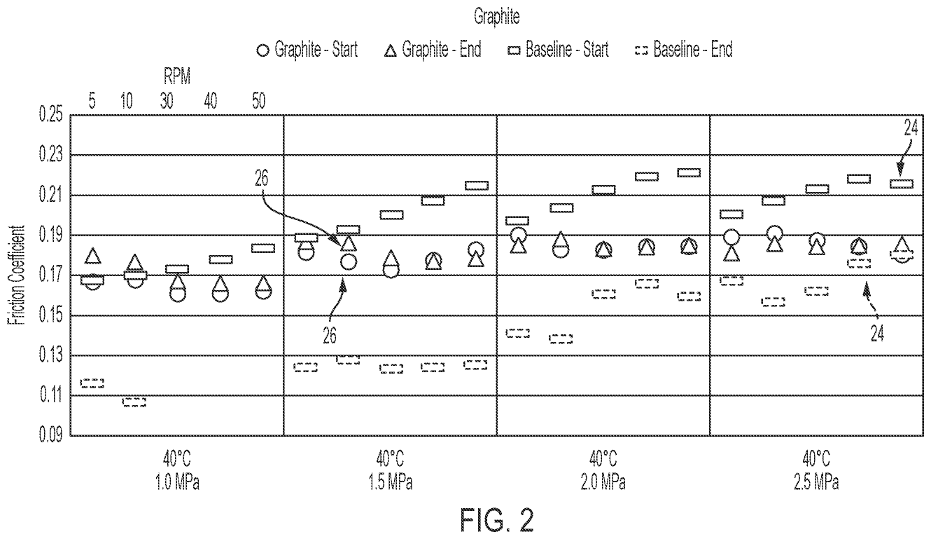

FIG. 2 shows a friction versus speed graph illustrating a friction material 24 including calcined kaolin clay without graphite and a friction material 26 including calcined kaolin clay with a graphite particles having a mean particle size of 35 to 85 microns, which illustrates the stability and durability advantages of using graphite particles having a mean particle size of 35 to 85 microns with calcined kaolin clay over a variety of speed ranges. The inventors discovered that using graphite particles having a mean particle size of 35 to 85 microns improved wet friction material performance in comparison with standard graphite particles having particle sizes of over 100 microns in regards to both static and dynamic friction coefficient.

Friction material 24 includes a material matrix that is 50% cotton fibers and 50% calcined kaolin clay and friction material 26 includes a material matrix that is 50% cotton fibers, 40% calcined kaolin clay and 10% graphite a having mean particle size of 44 microns, with both friction materials including tung modified phenolic resin representing 35% of the weight of the binder saturated and dried friction material.

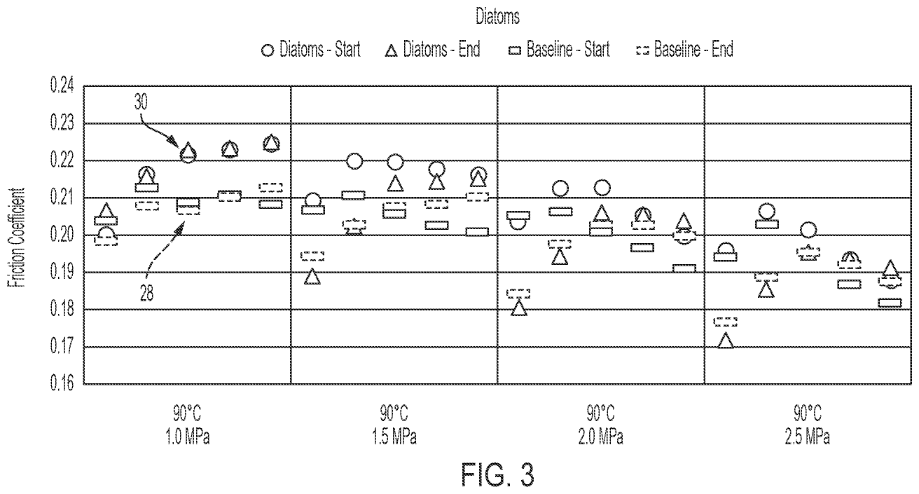

FIG. 2 shows test performed at the beginning and the end of the test cycles for both materials 24, 26 for applied pressures of 1.0 MPa, 1.5 MPa, 2.0 MPa and 2.5 MPa, with the friction coefficient measured at 5 RPM, 10 RPM, 30 RPM, 40 RPM and 50 RPM for each applied pressure. The tests were performed using FORD ultra low viscosity (ULV) automatic transmission fluid, which has a viscosity of 19.2 cSt at 40° C. and 4.5 cSt at 100° C. The ULV automatic transmission fluid had a temperature of 40° C. for the tests shown in FIG. 3. FIG. 3 shows that the friction coefficient surprisingly stayed within the range of 0.16 to 0.19 for material 26 across all rotational speeds and applied pressures tested, while the friction coefficient varied from 0.10 to 0.22 for material 24. Material 24 had an average friction coefficient of 0.201 at the start and 0.137 at end. Material 26 had an average friction coefficient 0.179 at the start and 0.181 at the end.

The inventors have also discovered that modifying the wet friction materials of U.S. Pub. No. 2018/0149222 A1 by substituting diatomaceous earth, which may have a mean particle size of 5 to 40 microns, for some of the calcined kaolin clay and using 31-35% of the weight of the binder results in a significant improvement in stability and durability.

In one preferred embodiment with diatomaceous earth and tung modified phenolic resin, wet friction material layer 12 may include, before being saturated by the binder, by percentage weight, 40-50% cellulose fibers, 10-40% calcined kaolin clay and 20-40% diatomaceous earth. Tung modified phenolic resin is added on in weight percent that is 31-35% of the weight of the binder saturated and dried friction material.

In another preferred embodiment with diatomaceous earth and tung modified phenolic resin, wet friction material layer 12 may include, before being saturated by the binder, by percentage weight, 40-50% cellulose fibers, 15-25% calcined kaolin clay and 25-35% diatomaceous earth. Tung modified phenolic resin is added on in weight percent that is 31-35% of the weight of the binder saturated and dried friction material.

FIG. 3 shows a friction versus speed graph illustrating a friction material 28 including calcined kaolin clay without diatomaceous earth and a friction material 30 including calcined kaolin clay with diatomaceous earth, which illustrates the stability and durability advantages of using diatomaceous earth at certain applied pressures and rotational speeds. Friction material 28 includes a material matrix that is 50% cotton fibers and 50% calcined kaolin clay and friction material 26 includes a material matrix that is 50% cotton fibers, 20% calcined kaolin clay and 30% diatomaceous earth a having mean particle size of 5-40 microns, with both friction materials including tung modified phenolic resin added on in weight percent that is 35% of the weight of the binder saturated and dried friction material.

FIG. 3 shows test performed at the beginning and the end of the test cycles for both materials 28, 30 for applied pressures of 1.0 MPa, 1.5 MPa, 2.0 MPa and 2.5 MPa, with the friction coefficient measured at 5 RPM, 10 RPM, 30 RPM, 40 RPM and 50 RPM for each applied pressure. The tests were performed using FORD ULV automatic transmission fluid having a temperature of 90° C. FIG. 3 shows that the friction coefficient surprisingly stayed within a tight and improved coefficient range of above 0.22 for material 30 in a speed range of 30 RPM to 50 RPM for the 1.0 MPa applied pressure and above 0.21 in a speed range of 30 RPM to 50 RPM for the 1.5 MPa applied pressure.

The inventors have also discovered that modifying the wet friction materials of U.S. Pub. No. 2018/0149222 A1 by substituting chopped aramid fibers for some of the cellulose fibers and using 31-35% of the weight of the binder results in a significant improvement in stability and durability.

In one preferred embodiment with chopped aramid fibers, wet friction material layer 12 may include, before being saturated by the binder, by percentage weight, 30-55% cellulose fibers, 5-20% chopped aramid fibers and 30-50% calcined kaolin clay. The binder being added on in weight percent that is 31-35% of the weight of the binder saturated and dried friction material.

In a further preferred embodiment with chopped aramid fibers, wet friction material layer 12 may include, before being saturated by the binder, by percentage weight, 45-55% cellulose fibers, 5-15% chopped aramid fibers and 35-45% calcined kaolin clay. The binder being added on in weight percent that is 31-35% of the weight of the binder saturated and dried friction material.

In a more specific advantageous embodiment, the chopped aramid fibers have a length of 2.8 to 3.2 mm. These chopped aramid fibers may advantageously have diameters of 10 to 25 microns.

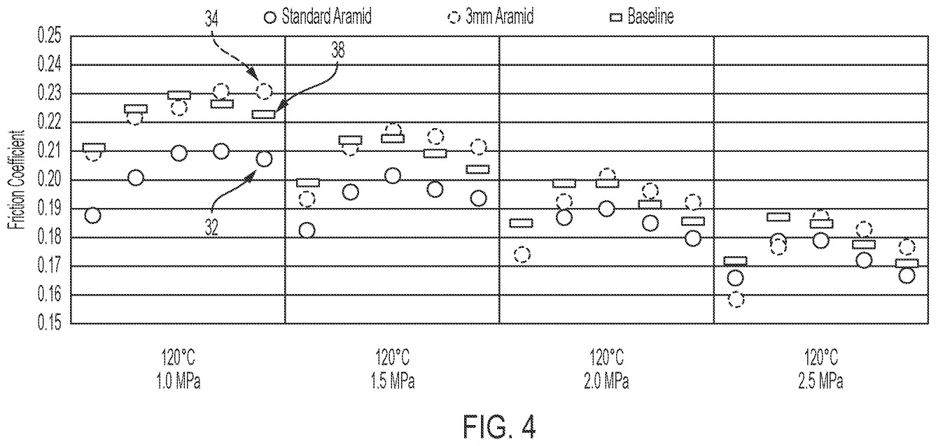

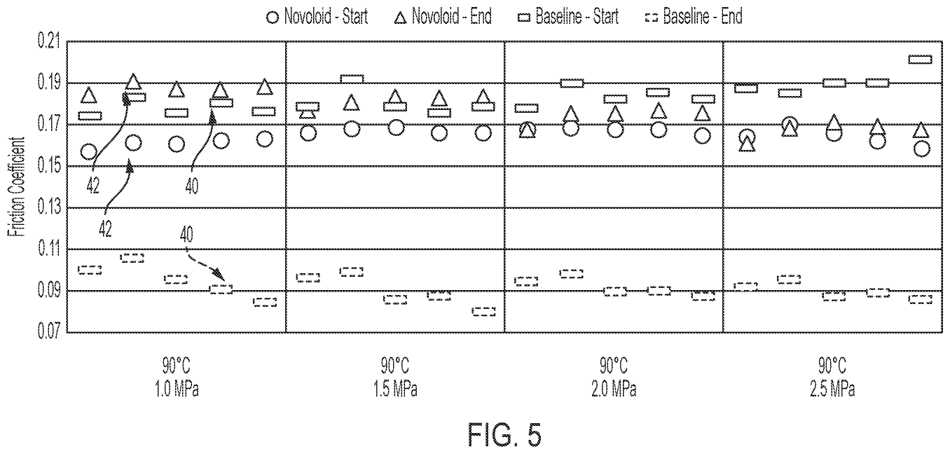

FIG. 4 shows a friction versus speed graph illustrating friction materials including calcined kaolin clay with different aramid fibers. A first friction material 32 includes typical aramid fibers, which are long fibrillated fibers that block the surface of the friction material lower the friction coefficient. A second friction material 34 includes 3.0 mm chopped aramid fibers. A third friction material 36 includes no aramid fibers. Friction materials 32, 34 include a material matrix that is 50% cotton fibers, 40% calcined kaolin clay and 10% aramid fibers, and friction material 36 includes a material matrix that is 50% cotton fibers and 50% calcined kaolin clay, with all of friction materials 32, 34 and 36 including tung modified phenolic resin binder added on in weight percent that is 35% of the of the weight of the binder saturated and dried friction material FIG. 5 shows test performed for applied pressures of 1.0 MPa, 1.5 MPa, 2.0 MPa and 2.5 MPa, with the friction coefficient measured at 5 RPM, 10 RPM, 30 RPM, 40 RPM and 50 RPM for each applied pressure. The tests were performed using FORD ULV automatic transmission fluid having a temperature of 120° C. FIG. 3 shows that the friction coefficient of material 34 being greater than that of material 32, and similar to that of material 38.

The second friction material 34 provides the best overall performance, as the friction coefficient is increased as compared to the first friction material 32, and the durability is higher than the third friction material 36.

The inventors have also discovered that modifying the wet friction materials of U.S. Pub. No. 2018/0149222 A1 by substituting chopped novoloid fibers for some of the cellulose fibers and using 31-35% of the weight of the binder results in a significant improvement in stability and durability.

In one preferred embodiment with novoloid fibers, wet friction material layer 12 may include, before being saturated by the binder, by percentage weight, 30-55% cellulose, 5-20% novoloid fibers and 30-50% calcined kaolin clay. The binder is 31-35% of the weight of the binder saturated and dried friction material.

In a further preferred embodiment with novoloid fibers, wet friction material layer 12 may include, before being saturated by the binder, by percentage weight, 45-55% cellulose, 5-15% novoloid fibers and 35-45% calcined kaolin clay. The binder is 31-35% of the weight of the binder saturated and dried friction material.

In a more specific advantageous embodiment, the novoloid fibers have a length of 0.2 to 0.35 mm. These novoloid fibers may advantageously have diameters of 10 to 45 microns.

FIG. 5 shows a friction versus speed graph illustrating a friction material 40 including calcined kaolin clay without novoloid fibers and a friction material 42 including calcined kaolin clay with novoloid fibers, which illustrates the stability and durability advantages of using novoloid fibers with calcined kaolin clay over a variety of speed ranges. Friction material 40 includes a material matrix that is 50% cotton fibers and 50% calcined kaolin clay and friction material 42 includes a material matrix that is 50% cotton fibers, 40% calcined kaolin clay and 10% novoloid fibers. The novoloid fibers have lengths of 0.2-0.35 mm and diameters of 10-45 μm. Both friction materials 40, 42 include tung oil modified phenolic resin added on in weight percent that is 35% of the binder saturated and dried friction material.

FIG. 5 shows test performed at the beginning and the end of the test cycles for both materials 40, 42 for applied pressures of 1.0 MPa, 1.5 MPa, 2.0 MPa and 2.5 MPa, with the friction coefficient measured at 5 RPM, 10 RPM, 30 RPM, 40 RPM and 50 RPM for each applied pressure. The tests were performed using FORD ULV automatic transmission fluid having a temperature of 90° C. FIG. 7 shows that the friction coefficient surprisingly stayed within the range of 0.16 to 0.19 for material 42 across all rotational speeds and applied pressures tested, while the friction coefficient varied from 0.08 to 0.20 for material 40.

To form wet friction material layer 12 shown in FIG. 1, the fibers, filler particles and any friction modifiers are joined together in a pulping process to form a base material. The pulping process involves forming a mixture of the fibers, particles and any friction modifiers submerged together in a liquid solution, then drying the mixture to remove the liquid. After the fibers, filler particles and friction modifiers are joined together by the liquid solution, the base material includes a matrix formed by the fibers, filler particles and friction modifiers that define a network of voids.

After the fibers, filler particles and friction modifiers are joined together, the base material is saturated with a binder, for example in the form of phenolic resin. The binder penetrates past an outer surface 12a into the interior of the wet friction material 12 such that voids in the interior of wet friction material 12 are saturated with the binder, but the outer surface 12a is exposed.

Wet friction material layer 12 can then be placed on top of the metal part 14 and layer 12 and part 14 are joined together to form a friction assembly. Prior to joining of layer and part 14, the binder is subject to initial curing to a level called B-stage, where the layer 12 is somewhat flexible. The joining of layer 12 and part 14 together includes pressing wet friction material layer 12 against metal part 14 with a heat plate to complete curing of the binder in wet friction material layer 12, fixing wet friction material layer 12 and metal part 14 together. The force of pressing of that heat plate against outer surface 12a of wet friction material layer 12, while inner surface 12b of wet friction material layer 12 rests on an outer layer 14a of metal part 14, causes the binder to accumulate at an interface of inner surface 12b of wet friction material layer 12 and outer surface 14a of metal part 14, while the curing of the binder by the heat of the heat plate creates a permanent connection between metal part 14 and wet friction material layer 12. The binder solidifies and hardens in wet friction material layer 12 in contact with the fibers, filler and friction modifier in the base material. In one preferred embodiment, the heat at a surface of the plate that contacts outer surface 12a is 375 to 425 degrees F.

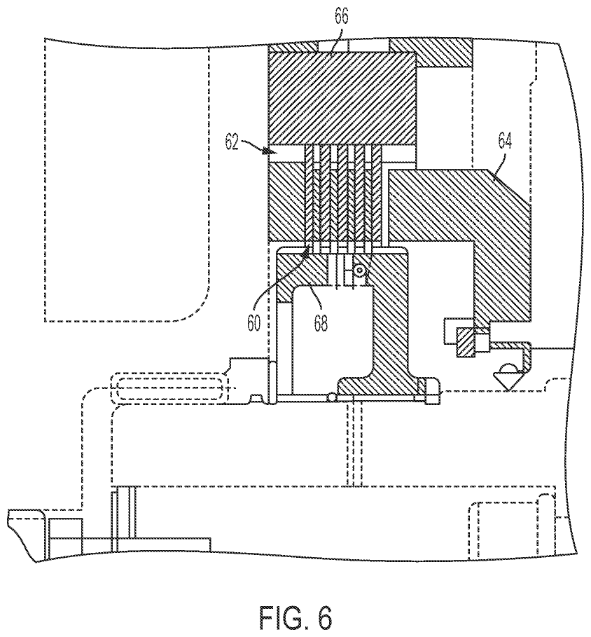

FIG. 6 shows wet friction material layer 12 bonded to a plurality of clutch plates 60 in a clutch pack 62. A piston 64 forces to clutch plates 60 together to couple parts 66, 68 together such that parts 66, 68 rotate together when the clutch pack 62 is engaged.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

12 wet friction material layer
12a outer surface
12b inner surface
30 metal part
30a outer surface
32 heat plate
32a surface
50 friction material with calcined kaolin clay and standard phenolic resin
52 friction material with calcined kaolin clay and tung modified phenolic resin
60 clutch plates
62 clutch pack
64 piston
66, 68 rotating parts

What is claimed is:

1. A clutch assembly for a motor vehicle drivetrain comprising:
a rigid support; and
a wet friction material fixed to a surface of the rigid support, the wet friction material comprising:
a base material including a matrix of fibers and filler particles embedded in the matrix of fibers; and
a binder embedded in the base material,
the base material comprising, by weight percent:
30-55% cellulose fibers;
10-50% calcined kaolin clay; and
at least one of:
1-20% graphite having a mean particle size of 35 to 85 microns;
20-40% diatomaceous earth in combination with the binder being tung modified phenolic resin;
5-20% chopped aramid fibers; or
5-20% of novoloid fibers.

2. The clutch assembly as recited in claim 1 wherein the base material comprises, by weight percent:
40-55% cellulose fibers;
20-49% calcined kaolin clay; and
1-20% graphite having a mean particle size of 35 to 85 microns.

3. The clutch assembly as recited in claim 2 wherein the base material comprises, by weight percent:
45-55% cellulose fibers;
35-45% calcined kaolin clay; and
5-15% graphite having a mean particle size of 35 to 85 microns.

4. The clutch assembly as recited in claim 1 wherein the base material comprises, by weight percent:
30-55% cellulose fibers;
10-40% calcined kaolin clay; and
20-40% diatomaceous earth,
the wet friction material including, by weight percent, 31 to 35% of tung modified phenolic resin.

5. The clutch assembly as recited in claim 4 wherein the base material comprises, by weight percent:
45-55% cellulose fibers;
15-25% calcined kaolin clay; and
25-35% diatomaceous earth,
the wet friction material including, by weight percent, 31 to 35% of tung modified phenolic resin.

6. The clutch assembly as recited in claim 1 wherein the base material comprises, by weight percent:
30-55% cellulose fibers;
30-50% calcined kaolin clay; and
5-20% chopped aramid fibers.

7. The clutch assembly as recited in claim 6 wherein the base material comprises, by weight percent:
45-55% cellulose fibers;
35-45% calcined kaolin clay; and
5-15% chopped aramid fibers.

8. The clutch assembly as recited in claim 6 wherein the chopped aramid fibers have a mean length of 2.8 to 3.2 mm.

9. The clutch assembly as recited in claim 6 wherein the chopped aramid fibers have a mean diameters of 10 to 45 microns.

10. The clutch assembly as recited in claim 1 wherein the base material comprises, by weight percent:
30-55% cellulose fibers;
30-50% calcined kaolin clay; and
5-20% novoloid fibers.

11. The clutch assembly as recited in claim 1 wherein the base material comprises, by weight percent:
45-55% cellulose fibers;
35-45% calcined kaolin clay; and
5-15% novoloid fibers.

12. The clutch assembly as recited in claim 10 wherein the novoloid fibers have a mean length of 0.2 mm to 0.35 mm.

13. The clutch assembly as recited in claim 10 wherein the novoloid fibers have a mean diameters of 10 to 45 microns.

14. The clutch assembly as recited in claim 1 wherein the wet friction material includes, by weight percent, 31 to 35% of the binder.

15. The clutch assembly as recited in claim 14 wherein the binder is tung modified phenolic resin.

16. A method of making a clutch assembly for a motor vehicle comprising:
fixing a wet friction material to a surface of a rigid support,
the wet friction material being made by:
providing a base material;
saturating the base material with binder; and
curing the binder,
the base material comprising, by weight percent:
30-55% cellulose fibers;
10-50% calcined kaolin clay; and
at least one of:
1-20% graphite having a mean particle size of 35 to 85 microns;
20-40% diatomaceous earth in combination with the binder being tung modified phenolic resin;
5-20% chopped aramid fibers; or
5-20% of novoloid fibers.

17. The method as recited in claim 16 wherein the binder is tung modified phenolic resin.
